(19) United States
(12) Patent Application Publication
(10) Pub. No.: US 2024/0400030 A1
(43) Pub. Date: Dec. 5, 2024

(54) BRAKE ASSEMBLY COMPRISING DEVICE FOR GENERATING WARNING SIGNAL

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/385,097

(22) Filed: Oct. 30, 2023

(30) Foreign Application Priority Data
May 31, 2023 (DE) 102023205092.7

(51) Int. Cl. B60T 17/22; B60Q 5/00; B60Q 9/00; B60R 16/02; F16D 65/00

(52) U.S. Cl. CPC B60T 17/22; B60Q 5/005; B60Q 9/00; B60R 16/0207; F16D 65/0031; F16D 65/0068; B60T 13/74; F16D 51/18; F16D 2055/0016; F16D 2055/0037; F16D 65/18; F16D 2121/18

(57) ABSTRACT

The disclosed caliper brake includes a piston configured to move forward and backward in an axial direction and a back plate provided to face a front side of the piston, wherein the piston is provided with a suction plate provided on a front surface of the piston and having a center concavely formed rearward to adsorb the back plate during the piston moving forward.

### CROSS-REFERENCE TO RELATED APPLICATION

This application claims the benefit of German Patent Application No. 102023205092.7, filed on May 31, 2023, in the German Patent Office (DPMA), the disclosures of which are incorporated herein by reference in its entirety.

### BACKGROUND

### 1. Technical Field

The invention relates in particular to a brake assembly for a vehicle wheel. The vehicle may in particular be a road vehicle, such as a car, a truck or a bus.

### 2. Description of the Related Art

Brake assemblies are typically optimized with respect to their braking function and without providing any dedicated function apart from braking.

On the other hand, space for placing components is limited in vehicles and achieving an optimum use of the available space is difficult to achieve.

The present invention is thus directed to the object of improving the usage of available installation space in vehicles.

### SUMMARY

The present invention is thus directed to the object of improving the usage of available installation space in vehicles.

This object is solved by the subject matter according to the attached independent claims. Advantageous embodiments are defined in the dependent claims, in this description and in the figures.

Accordingly, a brake assembly for braking a vehicle wheel is suggested, the brake assembly comprising at least one device, e.g., a loudspeaker or a light emission device, that is configured to generate a warning signal. The signal may be perceivable by other road users. It may e.g., be an acoustic warning signal (e.g., noise) and/or a visual warning signal (e.g., a light signal). The brake assembly may, e.g., in its entirety, be placed close to and in particular adjacent to a vehicle wheel. For example, the brake assembly may be placed, e.g., in its entirety, a wheel bay of a vehicle. All components of the brake assembly may be placed in close proximity to one another, e.g., not further apart than 50 cm, and/or be directly or indirectly connected to one another.

The brake assembly may be positioned at any vehicle wheel and at any of a front and rear axis. In a vehicle having a plurality of vehicle wheels, any number of brake assemblies according to this disclosure may be provided and any combinations of brake assemblies according to this disclosure and of differently configured brake assemblies may be provided.

The invention is based on the realization that brake assemblies can, contrary to known solutions, also be used to integrate other functions apart from braking. Specifically, brake assemblies have been identified as providing additional installation space for accommodating further components, in particular components that are unrelated to braking. Presently, this component is a device that is used to warning signals that are e.g., perceivable by humans. For example, the device may comprise a loudspeaker that is configured to generate horn-like noises and/or repetitive beeping noises. The warning signal (or, e.g., when repeated, the warning signals) may indicate a certain travelling direction of the vehicle (in particular a rearward travelling direction), a moving state of the vehicle (e.g., forward travelling at low speeds) and/or a general presence of the vehicle, e.g., to alert other road users, in particular approaching and/or adjacent road users.

The brake assembly may as such be configured to generate braking forces or may at least contribute to generate braking forces. For example, the brake assembly may be intended for generating braking forces when interacting with further components such as a brake disc that are not comprised by the brake assembly (or the brake assembly may alternatively comprise said components, too). For example, the brake assembly may form only part of an overall assembly configured to generate braking forces (or may alternatively resemble said overall assembly).

According to one embodiment, the brake assembly is a brake caliper assembly without, however, directly including a brake disc needed for actually generating braking forces. Similarly, the brake assembly may be or a comprise a drum brake without, however, directly including brake shoes needed for actually generating braking forces.

For example, the brake assembly may comprise at least one member (e.g., a brake disc or brake drum) that is configured to jointly rotate with the vehicle wheel and/or to be braked in order to decelerate the vehicle. Additionally or alternatively, the brake assembly may comprise (or be configured to carry) at least one member that is configured to contact and thus brake a member (e.g. a brake pad or brake shoe) that is configured to jointly rotate with the vehicle wheel.

The device may be electrically driven. Specifically, it may be configured to convert electric signals and/or electric energy into acoustic noise, e.g., by moving (in particular vibrating) a diaphragm, membrane or another component. The loudspeaker may comprise an electric linear motor for generating such movements. Generally, the loudspeaker may be configured according to prior art examples, but may be positioned differently from such prior art examples.

Alternatively or additionally, the device may be configured to convert electric signals and/or electric energy into light signals (as an example of a visual signal), e.g. by powering-on at least one light emitting diode (LED).

The visual signal may generally include a colored light signal, a steady light signal, a regularly or irregularly flashing light signal, a lighted icon or lighted symbol or a light letter or text. The visual signal may be visual at the brake assembly and/or may be projected onto a road surface or into another surrounding region. In the latter two cases, the visual signal may thus be visible at the surface at or against which it is projected.

The visual signal may be generated so as to not be (e.g. significantly) directed and/or emitted above a certain height, e.g. not above 0.5 m or not above 1.5 m from a road level. This may help to prevent a blinding of other road users. For example, a main light emission axis and/or a projection axis of the device (e.g. of at least one light emitting unit and/or of a projector unit comprised by said device) may be oriented to stay below of said height or may only cross said height after a certain distance of e.g. more than 4 m. For example, any of said axes may be oriented horizontally or may be tilted downwards. Additionally or alternatively, the device may be placed at or below of said certain height. It is to be understood that it may not always be possible to prevent that light also spreads above said height. Yet, the above embodiments seek to limit directly guiding or directly emitting light above said height at a high intensity, so that only a very reduced light intensity may be present above said height.

In sum, according to one embodiment, the device may be configured to generate the visual signals so that not more than 25% of the light intensity of the visual signals may be present above a certain height, e.g. a height of 0.5 m or 1.5 m from a road level.

The signal may include a warning in form of information e.g. about the state of the vehicle or about a traffic situation. The signal may generally be provided to capture the attention of other road users. The warning signal may thus alternatively be referred to as an information signal or as an attention signal.

According to a further example, the brake assembly is a brake caliper assembly that is in particular provided for being used in a vehicle disc brake. The brake caliper assembly may comprise a brake caliper housing. Also, it may comprise a brake pad carrier. The brake caliper housing may also be referred to as a caliper frame. The brake caliper housing may be configured to support and carry at least one brake pad that is movable relative to a braked member. The braked member may in particular be a brake disc of a vehicle disc brake. The brake caliper housing may be configured to receive a brake piston and/or to house at least part of a (e.g. electric or hydraulic) brake actuating mechanism. Also, the brake caliper housing may be movable and/or may be configured to move at least one brake pad and in particular force it into contact with a brake disc.

The brake caliper housing may receive and surround at least part of the brake disc, such as a radially outer section, and/or may face opposite sides of the brake disc. This way, a pair of brake pads that are supported by the brake caliper assembly can be arranged on opposite sides of the brake disc. In a generally known manner, the brake pads can thus clamp the brake disc in between them.

Each brake pad may be arranged at one of a first and second inner face of the brake caliper housing and specifically at a so called finger side or piston side of the brake caliper housing. Said inner faces and said sides may lie on opposite sides of the brake disc and/or may be spaced apart from one another along a rotational axis of the braked member. The piston side and the finger side may be connected by a bridge section. The bridge section may extend along and in particular substantially in parallel to a rotation axis of the brake disc. It may span axially across the brake disc and/or extend from one side of the brake disc to the other. It may face an outer circumference of the brake disc.

The brake caliper housing may be movable, in particular relative to a preferably stationary brake pad carrier.

The brake pad carrier may generally be configured to carry and/or guide the brake pads when being displaced towards and away from the brake disc. For example, the brake pad carrier may comprise guiding grooves in which guiding projections (e.g. so-called guiding ears) of at least one brake pad are received. The brake pad carrier may define a frame-like structure extending substantially orthogonally to the brake disc (e.g. to side faces of the brake disc that are contacted by the brake pads) and/or receiving (or put differently surrounding) at least part of the brake disc, e.g. part of an angular sector and/or a circumferential outer edge portion of the brake disc.

According to one example, the device is arranged in a recess of a component of the brake assembly. For example, the recess may be provided in one of the brake caliper housing and brake pad carrier. For example, the device may be fully received in said recess, e.g. so as not define any projections at an outer surface of the component, e.g. an outer surface of the respective one of the brake caliper housing and brake pad carrier. For example, the recess may be dimensioned for receiving the device such that the device is flush with the outer surface. By arranging the device in a respective recess, an extent of projections or other interfering contours at components of the brake assembly can be reduced. This e.g. limits a risk of brake dust or dirt accumulating at the brake assembly.

The recess may be provided in an outwardly facing surface of the component, e.g. an outwardly facing surface of the respective one of the one of the brake caliper housing and brake pad carrier. Said surface may face away from a brake disc of the vehicle disc brake and may thus face outwardly. It may generally face away from a center of the vehicle and/or towards other road users. Placing the recess in this manner enables a preferred spreading direction of the generated warning signal. Specifically, said signal may spread outwardly towards other road users.

According to a further example, the device is arranged at a surface (in particular an outwardly facing surface) comprised by a finger portion of the brake caliper housing. This ensures a particularly close proximity of the device to other road users. For example, only a rim of the vehicle wheel which often has large cut-outs may be arranged in between the device and the surroundings of the vehicle.

Alternatively, the device may be arranged at a surface comprised by a bridge section of the brake caliper housing. This represents a particularly large and typically unoccupied surface that, moreover, tends to experience below average deformations during braking. Thus, the device can be reliable secured at said surface over a long time span.

Still further, the device may be arranged at a surface comprised by a trailing edge portion or a leading edge portion of the brake caliper housing. The trailing edge and leading edge may be defined according to known examples in the prior art. Specifically, with respect to a forward rotating direction of the vehicle wheel and/or a brake disc or a brake drum, the leading edge may be positioned further ahead in said forward direction compared to the trailing edge. Generally, the trailing edge and leading edge may be side edges of the brake caliper. They may extend along the rotation axis. They may extend at an angle to the brake pads and/or to a finger side and/or a piston side of the brake caliper housing. Placing the device at said edges makes use of an unoccupied space that is not prone to excessive deformations or vibrations.

In one embodiment, the brake assembly further comprises an electric line (or, put differently, an electric wire or a cable) connected to the device. This electric line is preferably flexible to compensate for an optional movement of the device when operating the brake assembly. For example, the electric line may at one end be connected to the device. At another end, it may be connected to some other vehicle component (e.g. a component that is external of the brake assembly, such as a control unit). The device may be movable relative to said other vehicle component. This relative movement is accounted for by a flexibility of the electric line. For example, the electric line may as such be elastically deformable and/or may be movable, elongateable or unfoldable in case the device moves when operating the brake. Such a movement may e.g. occur when arranging the device at the brake caliper housing.

By providing a respectively flexible electric line, the device can be reliably operated even at frequent brake activations.

The electric line may carry electric signals that are configured to drive the device and/or to prompt the device to generate the warning signal. These signals may thus power and/or control the loudspeaker.

According to another embodiment, the brake assembly further comprises at least one electric brake actuator (e.g. a park brake actuator) connected to at least a first electric line and the brake assembly further comprises a second electric line connected to the device. In this case, at least a section of the first electric line and at least a section of the second electric line may be comprised by a common harness (e.g. a cable harness or wire harness). This harness may at least partially be placed outside of the brake assembly. The harness may e.g. be connected to a vehicle control unit that is positioned remotely from the brake assembly.

This embodiment is advantageous in that it increases a functional integration of the harness. For example, the harness may already be provided according to known designs that comprise the actuator, so that a space within the vehicle and/or close to or at the brake assembly is already intended for the harness. Therefore, using this harness to also connect the device saves space and costs compared to adding a further harness for the same purpose.

In one implementation, the device is at least partially covered by a cover, in particular wherein the cover is movable. The cover may have a protective function, e.g. against moisture, brake dust and/or dirt. The cover may cover a part of the device that faces outwardly. In particular when being not movable, the cover may be sound-and/or light-permeable. For example, the cover may be transparent, porous, perforated, have a net-like structure and/or comprise a regular or irregular arrangement of through-holes.

According to another example, the cover comprises (or is made of) a brake dust collecting material. The brake dust collecting material may be an adhesive material, e.g. a glue. The adhesive material may be provided at at least one surface of the cover, in particular at a surface facing away from the device and into the surroundings. The adhesive material may comprise a layer or lining comprising glue or another adhesive substance to which brake dust may adhere.

Additionally or alternatively, the material may be configured to collect brake dust in e.g. a filter-like manner. For example, the cover may (additionally or alternatively) comprise at least one of the following materials:
a magnetic material;
an air-permeable material;
a porous material;
a material having a surface structure (e.g. a regular or irregular surface profile) configured to gather and in particular trap dust particles.

Especially the middle two materials may also provide a sound-and/or light-permeable function as discussed above.

Any of above-listed materials may form an exposed surface of the cover, in particular wherein said exposed surface faces into the surroundings. Non-limiting examples of an air-permeable material and/or a porous material include a textile material, a wool material, a felt material, a filter material, a mesh material and a foam material.

The surface structure for trapping dust particles may comprise openings, cavities, recesses or any other structural feature in which the brake dust may be trapped. These structural features may e.g. be formed by an increased surface roughness. For example, a porous material may define a respectively rough surface structure.

Making the cover movable may enable a selective removal of the cover when generating the warning signal. This helps to increase the volume in case the signal is a warning noise and/or the visibility in case of a visual warning signal. When the device does not generate warning signals, the cover may be moved into and stay in a position in which it at least partially covers or, put differently, at least partially shields the device from the surroundings.

The cover may have a movement actuator, e.g. an electric motor. An electric line connected to said electric motor may be flexible and/or may be comprised by a same harness as an optional electric line connected to the device. Accordingly, the electric lines of the motor for moving the cover and of the device may be jointly laid and/or jointly arranged over a long distance, thereby saving installation space.

One aspect provides that the brake assembly is a drum brake assembly comprising a brake drum and at least one brake shoe, wherein the device is arranged at one of the brake drum and the brake shoe. Generally, any of the above aspects described in connection with the brake caliper assembly may also be applied to the drum brake assembly, if not evident otherwise. This includes, in particular, an arrangement of the device in a recess, an arrangement of the device at an outwardly facing surface (e.g. at an outer circumferential surface of the brake drum), any of the aspects disclosed in connection with an electric line connected to the device and any of the aspects relating to a cover for at least selectively covering the device.

For generating visual warning signals, the device may e.g. comprise a flexible member, e.g. a foil or sheet, to which light emitting units (e.g. LEDs) are attached. Such a device (but generally a device according to any of the aspects disclosed herein) may e.g. be glued to the brake assembly.

The invention also relates to a system comprising a brake assembly configured as a brake assembly according to any aspect disclosed herein, the system further comprising a control unit, the control unit being configured to generate (e.g. control and/or electric) signals prompting the device to generate the warning signal. The control unit may e.g. comprise at least one processor and/or at least one memory. The memory may store program instructions that, when executed by the processor, enable the control unit to generate the signals for operating the device. These signals may be electric signals that are configured to directly drive the device (e.g. to drive an optional motor or other actuator thereof), thereby producing the warning signal. Alternatively, the signals may be processed by an optional control unit of the device. For example, the signals may be digital signals.

The control unit of the brake assembly may be connected to at least one other control unit and/or to at least one sensor of the vehicle. Based on signals received from said other control unit and/or sensor, the control unit may be configured to generate signals for operating the device.

By integrating the control unit into the brake assembly, adaptions to an existing control architecture of a vehicle may be limited. For example, the brake assembly may thus be a fully integrated unit that e.g. only needs electric energy and/or sensor signals from the vehicle to operate as intended. This helps to simplify retrofitting the brake assembly into existing vehicles and increases its compatibility to different vehicle models.

The invention also relates to a brake caliper housing for a brake assembly that is configured as a brake assembly according to any aspect disclosed herein, wherein the device is arranged at the brake caliper housing.

The invention also relates brake pad for a brake assembly that is configured as a brake assembly according to any aspect disclosed herein, wherein the device is arranged at the brake pad. For example, the device may be arranged at rear face or side edge of the brake pad. For example, the device may be arranged at backplate of the brake pad, e.g. in a recess thereof.

The invention also relates to a brake pad carrier for a brake assembly that is configured as a brake assembly according to any aspect disclosed herein, wherein the device is arranged at the brake pad carrier.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view of a brake assembly in form of a brake caliper assembly according to an embodiment of the invention.

FIG. 2 is another perspective view of a brake assembly in form of a brake caliper assembly according to an embodiment of the invention.

FIG. 3-4 are schematic views illustrating the arrangement of a loudspeaker in a recess according to embodiments of this invention.

FIG. 5 is a perspective view of a brake assembly in form of a brake caliper assembly according to an embodiment of the invention, the brake caliper assembly comprising a movable cover.

FIG. 6 is a perspective view of a brake assembly in form of a brake caliper assembly according to an embodiment of the invention, the brake caliper assembly comprising a stationary cover.

FIG. 7 is a view of a brake assembly according to another embodiment of the invention and in which the brake assembly is configured as a drum brake assembly.

FIGS. 8-10 show exemplary visual signals generated by a brake assembly according to other embodiments of the invention.

### DETAILED DESCRIPTION OF EMBODIMENTS

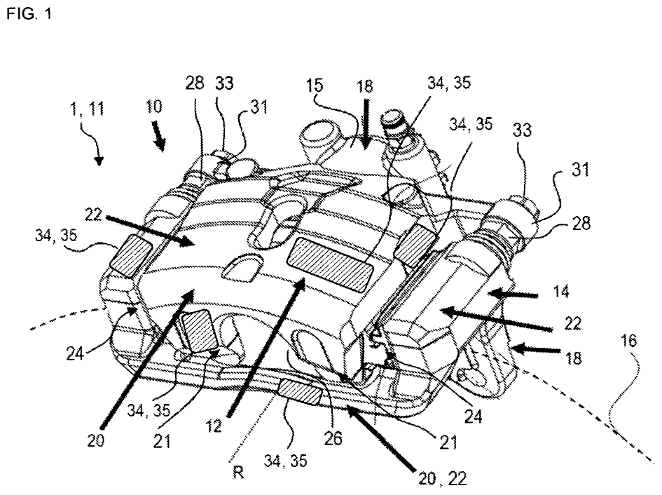

FIG. 1 shows a brake assembly 1 in form of a brake caliper assembly 10 of a vehicle disc brake 11, the brake caliper assembly 10 being configured according to generally known floating caliper principles. The brake caliper assembly 10 comprises a brake caliper housing 12 that is slidingly supported by a stationary brake pad carrier 14.

The brake caliper assembly 10 is generally configured to press brake pads 26 (one of which is partially visible in FIG. 1) against a brake disc 16. The brake pads 26 are received in and guided by the brake pad carrier 14. Only part of an outer circumferential edge of the brake disc 16 is indicated by a dashed line in FIG. 1, the brake disc 16 generally being configured according to known examples. Further, a rotation axis R about which the brake disc 16 rotates is schematically indicated by a dotted line in FIG. 1.

The brake caliper housing 12 comprises a receiving section 15. Only an outer wall of said receiving section 15 is visible in FIG. 1 and the receiving section 15 is formed as an (non-visible) open cylindrical cavity. In said receiving section 15, a non-illustrated brake piston is received.

The brake caliper housing 12 comprises a piston side 18 located at a first side face of the brake disc 16 and specifically at the same side face as the receiving section 15. Further, the brake caliper housing 12 comprises a finger side 20 located at the respective opposite side face of the brake disc 16 compared to the piston side 18. The finger side 20 comprises (merely as an example) two finger portions 21 according to known configurations.

The finger side 20 and the piston side 18 are connected to one another by a bridge section 22. The bridge section 22 overlaps with the outer circumferential surface of brake disc 16 or, put differently, axially spans across the brake disc 16 and/or extends from one of the side faces of said brake disc 16 to the other.

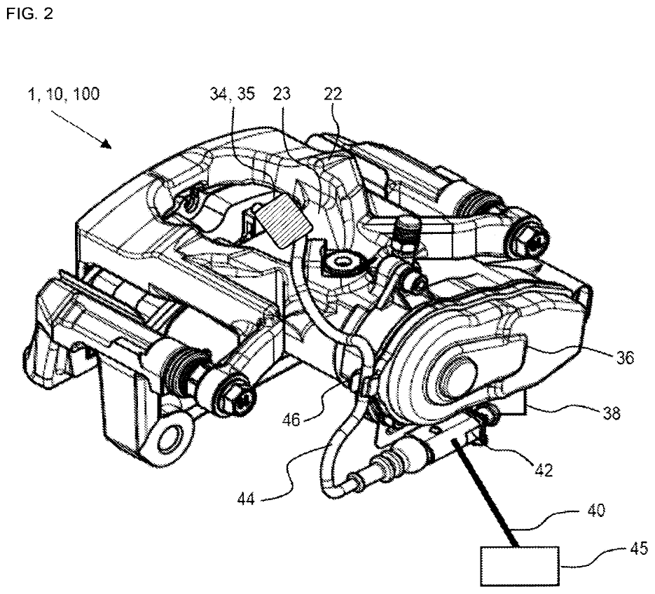

In a generally known manner, the brake piston received in the receiving section 15 and the inside of the finger portions 21 that face away from the viewer in FIG. 2 are configured to rest against the brake pads 26 and to press them against the brake disc 16.

Just like the brake caliper housing 12, the brake pad carrier 14 comprises a piston side 18, a finger side 20 and a bridge section 22.

Guiding grooves 24 are provided at an inner side of the bridge section 22 of the brake caliper housing 12 for slidingly receiving the two brake pads 26, one of said guiding grooves 24 being partially visible in FIG. 1. The brake pads 26 are located on opposite side faces of the brake disc 16. The brake pads 26 are generally identical to one another, but are oriented differently to face the different side faces of the brake disc 16.

FIG. 1 also illustrates that the movable brake caliper housing 12 is slidingly supported by and guided relative to the brake pad carrier 14 by means of guide pins 28 at both of a trailing side and leading side of the brake caliper assembly 10.

According to the configuration of FIG. 1, the guide pins 28 are each received in a non-illustrated cylindrical blind hole in the brake pad carrier 14. An axial length of said blind holes exceeds that of the guide pins 28, so that the latter may axially slide back and forth within the blind holes.

The guide pins 28 are secured to the brake caliper housing 12 by means of a screw connection. Specifically, fixing projections 31 are provided at each of a trailing side and a leading side of the brake caliper housing 12, said fixing projections 31 each comprising a non-visible through-hole. A guide pin 28 is aligned with each of said through holes to engage with a locknut 33 provided at an opposite side of the fixing projections 31. This way, the guide pins 28 are mechanically fixed to the fixing projections 31 and thus to the brake caliper housing 12.

In the following, embodiments of this disclosure are discussed in connection with FIGS. 1-7 that comprise a loudspeaker 34 as one example of a device 35 generating a warning signal and specifically an acoustic warning signal. Yet, these embodiments may also be provided with a device 35 that is, additionally or alternatively, configured to generate a visual warning signal. Thus, the loudspeaker 34 as discussed in the following may in each case be replaced with a respective device 35 generating visual warning signals (or a combination of acoustic and visual devices) to form other embodiments of this disclosure.

FIG. 1 indicates preferred positions for arranging loudspeakers 34. Any combination of the depicted loudspeakers 34 may be provided, including only one of said loudspeakers 34 being provided. The leftmost loudspeaker 34 is arranged at the brake pad carrier 14 and, as a mere optional example, at a leading side thereof (assuming the brake disc 16 rotates in the left direction of FIG. 1). The brake pad carrier 14 further comprises a loudspeaker 34 at its bridge section 22. The other loudspeakers 34 are arranged at the brake caliper housing 12. Specifically, the leftmost loudspeaker 34 arranged at the brake caliper housing 12 is arranged at one of the finger portions 21 at the finger side 20. The rightmost loudspeaker 34 is arranged at a trailing edge portion of the brake caliper housing 12. The middle loudspeaker 34 is arranged at the bridge section 22 of brake caliper housing 12. It is noted that each of the loudspeakers 34 is arranged at an outwardly facing external surface of the brake caliper assembly 10, said surfaces facing away from the brake disc 16.

Although not specifically illustrated, any of the brake pads 26 may equally carry a loudspeaker 34. This loudspeaker 34 may e.g. be arranged at a backplate and specifically a rear face of the brake pad 26 facing the viewer in FIG. 1. An electric connection to said loudspeaker 34 may be provided in a similar manner as explained below with reference to the second electric line 44 of FIG. 2.

FIG. 2 is a rear view of a brake caliper assembly 10 that is largely similar to that of FIG. 1. A difference exists in that this brake caliper assembly 10 further comprises a parking brake actuator 36 that is arranged at the piston side 18 of the brake caliper housing 12. The parking brake actuator 36 is electrically connected to a non-illustrated power supply via a schematically illustrated first electric line 38. This first electric line 38 is comprised by a schematically illustrated harness 40. The harness 40 also comprises a second electric line 44 that is connected to a loudspeaker 34 arranged at a top side 23 of the brake caliper housing 34 adjacent to the bridge section 22.

The first and second electric line 38, 44 are optionally branched at an optional branch unit 42. This means that for a large share of their respective lengths, the first and second electric line 38, 44 are comprised by the common harness 40. This saves space and costs.

From FIG. 2, it is also apparent that the second electric line 44 is flexible. For example, it is generally loosely held at the brake caliper housing 12 by an optional clamp 46. As a result, it comprises a number of curved sections. In case the branching unit 42 is optionally placed at a non-movable vehicle component, or the harness 40 is generally stationary, the second electric line 44 can follow a movement of the floating brake caliper housing 12 and thus of the loudspeaker 34 when braking. This may include that the second electric line 44 straightens and changes its curvatures accordingly. Also, the second electric line 44 may slide through and along the clamp 46 to follow the respective movement. Typically, the range of movement of the brake caliper housing 12 is limited to several millimeters, e.g. not more than 20 mm.

FIG. 2 also illustrates that at least the second electric line 44 as comprised by the harness 40 may be connected to a control unit 45. This control unit 45 is configured to generate signals for operating the loudspeaker 34, in particular electric (power) signals that are directly used to drive an actuator of the loudspeaker 34. The control unit 45 along with the brake assembly 1 form a system 100 according to an embodiment of this invention.

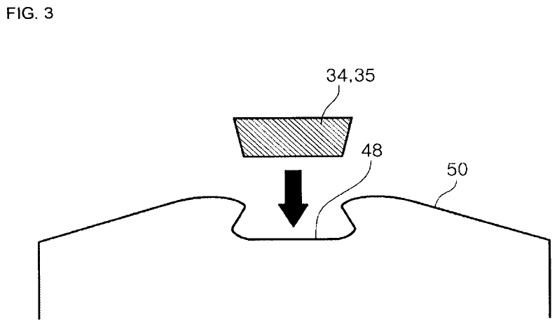

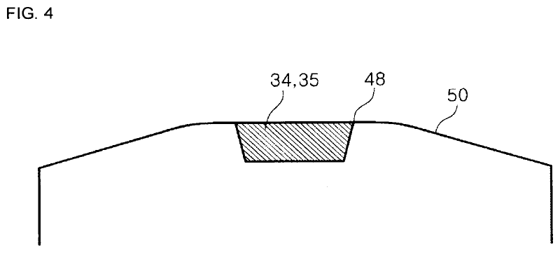

FIGS. 3 and 4 illustrate embodiments of placing a loudspeaker 34 in a recess 48. This can be implemented in any of the embodiments according to FIGS. 1 and 2 or also independently thereof in other embodiments according to this invention. The component may e.g. be a brake caliper housing 12 or a brake pad carrier 14 according to FIGS. 1 and 2.

The recess 48 is formed in an outer surface of the component 50 and configured to receive the loudspeaker 34 in full. Accordingly, when placed in the recess 48 (see arrow in FIG. 3), the loudspeaker 34 is accommodated in the recess 48 so that an upper side thereof is flush with the outer surface of the brake caliper housing 12. This means that the loudspeaker 34 is held particularly reliable in the recess 48 and limits protrusions at which brake dust or dirt may gather.

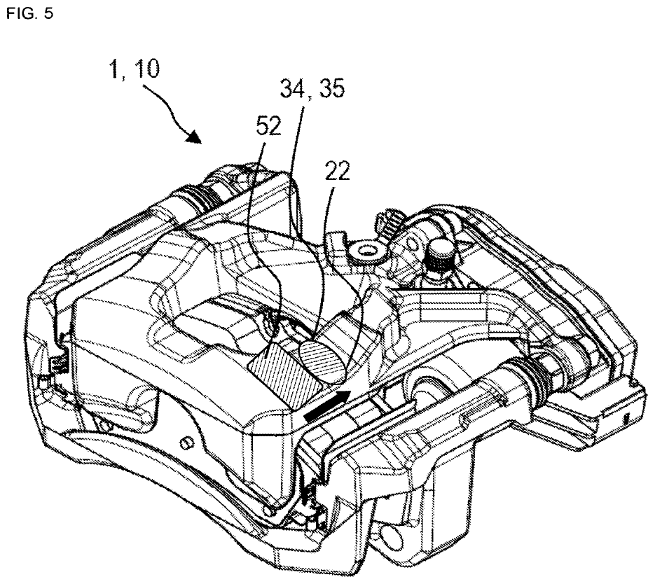

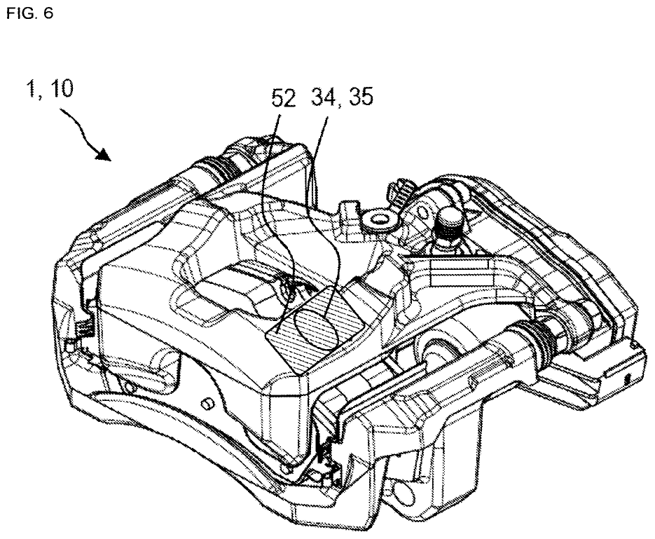

FIGS. 5 and 6 illustrate examples in which the brake caliper assembly 10 further comprises a cover 52. The brake caliper assembly 10 is generally configured similar to FIGS. 1 and 2, so that only the differences to these embodiments will be discussed. It is to be understood that any features of FIGS. 5 and 6 can also be implemented in the embodiment of FIGS. 1 and 2. In both cases, the loudspeaker 34 is placed at an outwardly facing surface of (as an example) the bridge section 22 of the brake caliper housing 12.

In FIG. 5, the cover 52 is shown in a retreated position in which the loudspeaker 34 is exposed. This retreated position is assumed temporarily when the loudspeaker 34 is supposed to be activated. For assuming this position, the cover 52 is moved by a non-illustrated actuator. As indicated by an arrow in FIG. 5, the cover 52 is also movable into a position in which fully covers the loudspeaker 34. In this position (which may be similar to the one indicated in FIG. 6), the cover 52 may help to shield the inactive loudspeaker 34 from brake dust or other environmental impacts.

FIG. 6 shows a non-movable cover 52. This cover permanently shields the loudspeaker 34 from environmental impacts. The position of the loudspeaker 34 is indicated by a dashed line in FIG. 6.

In both of FIGS. 5 and 6, the cover 52 may comprise or be formed out of a dust collecting material according to any of the examples disclosed herein.

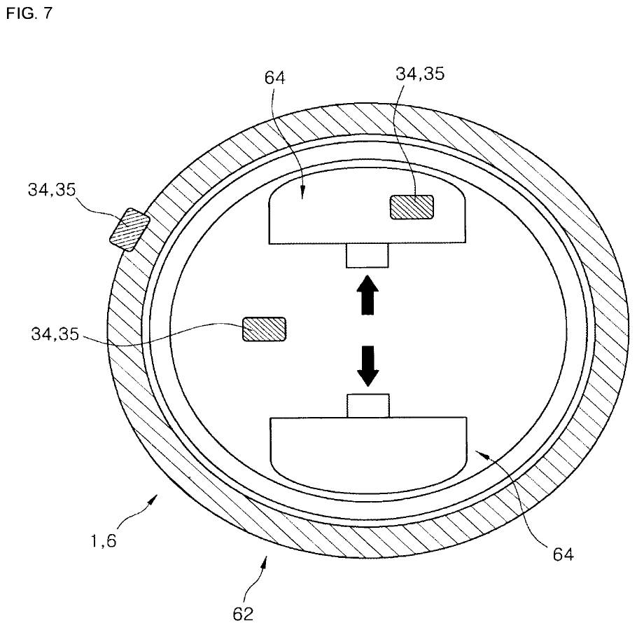

FIG. 7 illustrates another embodiment in which the brake assembly 1 is configured as a drum brake assembly 60. Again, possible positions of a loudspeaker 34 are indicated, wherein only one of the depicted loudspeakers 34 or any other number and combination thereof may be present. A leftmost loudspeaker 34 is positioned at an outer circumferential surface of the brake drum 60. A rightmost loudspeaker 34 is positioned at a brake shoe 64. A middle loudspeaker 34 is positioned at a base plate (or, put differently, at a rear wall) of the base drum 34.

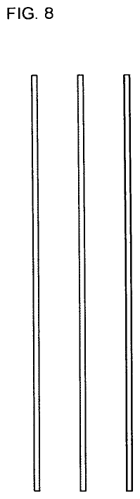

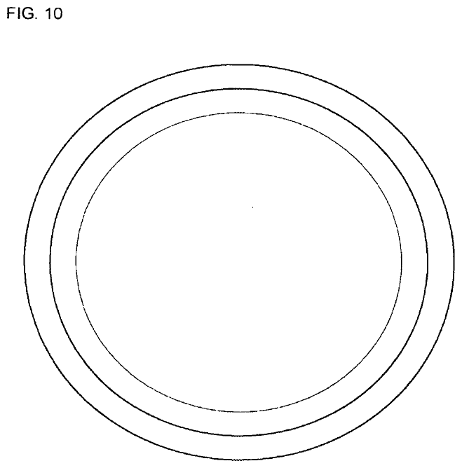

FIGS. 8-10 show exemplary warning signals in form of visual signals and specifically light signals. These are generated by non-illustrated brake assemblies 1 according to other embodiments of this invention. In these embodiments, the non-illustrated device 35 is configured to generate visual signals by, for example, powering on at least one light emitting unit. The examples indicate shapes of the visual signal as e.g. visible by a human when looking at the brake assembly 1 and with a vehicle wheel removed or through cut-outs in a rim of the vehicle wheel.

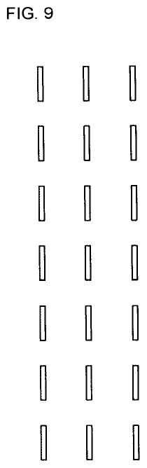

FIG. 8 shows a visual signal comprising plurality of continuous lines, while FIG. 9 shows a visual signal comprising plurality of discontinuous lines. The lines of these figures may have the same or different colours. The colours may switch, e.g. regularly or irregularly, or may be stable. The number, dimensions and curvature of the lines is only by way of example. The device 35 may e.g. comprise LEDs that are arranged corresponding to the lines.

FIG. 9 shows a circular visual signal. Again, the signal comprises a number of lines, but only one line or more lines than depicted may be provided as well. The lines may be configured according to any examples discussed in connection with FIGS. 8 and 9, e.g. in term of colors and color switching. The circular shape may be generated by a correspondingly arranged plurality of LEDs or by at least one LED coupled to a rotating component (e.g. a brake drum) of the brake assembly, thus generating the depicted circular appearance when rotating.

Not specifically depicted is another embodiment in which the visual signal comprises a lighted icon, a lighted symbol, a lighted letter or a lighted text.

What is claimed is:

1. Brake assembly for braking a vehicle wheel,
the brake assembly comprising at least one device that is configured to generate an acoustic and/or a visual warning signal.

2. Brake assembly according to claim 1,
wherein the brake assembly is a brake caliper assembly comprising a brake caliper housing and a brake pad carrier.

3. Brake assembly according to claim 2,
wherein the device is arranged in a recess, the recess being provided in one of the brake caliper housing and the brake pad carrier.

4. Brake assembly according to claim 3,
wherein the recess is provided in an outwardly facing surface of the respective one of the one of the brake caliper housing and brake pad carrier, said surface facing away from a brake disc that is to be braked by the brake assembly.

5. Brake assembly according to claims 2,
wherein the device is arranged at a surface comprised by a finger portion of the brake caliper housing or at another outwardly facing surface of the brake caliper housing or brake pad carrier.

6. Brake assembly according to claim 2,
wherein the device is arranged at a surface comprised by a bridge section of the brake caliper housing.

7. Brake assembly according to claim 2,
wherein the device is arranged at a surface comprised by a trailing edge portion of the brake caliper housing or by a leading edge portion of the brake caliper housing.

8. Brake assembly according to claim 1,
wherein the brake assembly further comprises an electric line connected to the device, this electric line being flexible to compensate for a movement of the device when operating the brake assembly.

9. Brake assembly according to claim 1,
wherein the brake assembly further comprises at least one electric brake actuator connected to at least a first electric line and the brake assembly comprises a second electric line connected to the device, wherein at least a section of the first electric line and of the second electric line are comprised by a common harness.

10. Brake assembly according to claim 1,
wherein the device is at least partially covered by a cover, in particular wherein the cover is movable.

11. Brake assembly according to claim 10,
wherein the cover comprises a brake dust collecting material.

12. Brake assembly according to claim 1,
wherein the brake assembly is a drum brake assembly comprising a brake drum and at least one brake shoe, wherein the device is arranged at one of the brake drum and brake shoe.

13. System,
comprising a brake assembly according to claim 1 and comprising a control unit, the control unit being configured to generate signals prompting the device to generate the warning signal.

14. Brake caliper housing for a brake assembly according to claim 1,
wherein the device is arranged at the brake caliper housing.

15. Brake pad for a brake assembly according to claim 1,
wherein the device is arranged at the brake pad.

16. Brake pad carrier for a brake assembly according to claim 1,
wherein the device is arranged at the brake pad carrier.
